(19) United States
(12) Patent Application Publication
(10) Pub. No.: US 2005/0204787 A1
(43) Pub. Date: Sep. 22, 2005

(54) Hotel in-room safe automated control and communication system

(76) Inventors: Nick Ernst, Victoria (CA); Kenneth Ian Soutar, Victoria (CA); Clifford Edmund Haslam, Victoria (CA)

Correspondence Address: Diane Kneeland, 148 Pecos St., Cedar Creek, TX, 78612, US

(21) Appl. No.: 11/078,134

(22) Filed: Mar. 11, 2005

Related U.S. Application Data
(60) Provisional application No. 60/554,361, filed on Mar. 19, 2004.

(51) Int. Cl. E05B 49/00

(52) U.S. Cl. 70/278.7; 340/5.33; 340/568.1

(57) ABSTRACT

An in-room safe monitoring, billing and tamper warning system that uses short range radio signals to pass the information to the internet, telephone system or any other Building Wide Communication Network (BCN). Attached to this BCN are the hotel's main computers used for security and billing. Thus the hotel staff can be informed of both usage and receive theft warning alarm messages through their regular computer network. The unique feature of this system is that data can be sent from any location in the room wirelessly throughout the room. A different code is associated with each and every safe, so that if the signal penetrates to the next room there will be no confusion. Once the signal reaches the wall, it is picked up by a data receiver and converted into the BCN format of choice for that building. Thus local short range radio communication can be used for building wide coverage in a huge hotel.

### BACKGROUND

1. Field of the Invention

Auto-billing in-room safe for large hotels.

2. Prior Art

There have been many attempts over the last few decades to automate the rental charge for in-room safe usage. The authors have been engaged in research along these lines for over a decade and have seen the need for an automated in-room safe system that simply charges the room for its own usage whenever it is used. In addition it is important that the safe be not tied down by communication cables or power lines because hotels often re-arrange the rooms when furniture or appliances are changed.

There have been previous systems for remotely dealing with locking mechanisms using radio remote control such as U.S. Pat. No. 5,646,605 to Leonaggeo et al. (1997) This patent allows locked cabinets and desks to be opened by a combination of radio and telephone.

A company El-Safe has been selling for several decades a system that allows for in-room safes to be billed automatically when they are used. Their technology requires that thousands of wire links be maintained throughout the hotel. It has proven to be expensive to maintain and newer solutions are needed.

We have a radio remote control system of our own (patent pending) that remotely “enables” or “disables” a room safe's basic operation. The guest is ultimately responsible for entering their combination code and is the one to open and close the safe. It has a dis-advantage of requiring an FCC licenced high powered radio pager system. There is no guarantee that some part of the hotel will not receive the pager system due to excessive metal in the building blocking the signal. This new system does not require long distance radio communication and is free from this problem. Also there is no need to obtain a radio licence from the FCC.

Our current invention is the first such in-room safe control system that simply charges the guest whenever it is used. This is done wirelessly by the use of a short range transmitter/receiver pair. The signal does not leave the room. Once the signal is received at the edge of the room the data can be re-directed over the telephone or internet to the hotel front desk computers that do the room billing. As far as we know it is the only self billing in-room safe system for hotels.

Functional Description of Invention

This system is designed to allow in room safes in a hotel to automatically post billings to the guests when they use the safe. The following sequence describes the use of the system. FIG. 1 is a diagram showing the functional components. Additional diagrams show construction detail of the components. If no figure numbers are stated it is assumed we are working with FIG. 1, the overall diagram.

1/A Guest places something in the safe (a) and locks it.

2/The door lock sensor is detected by the single chip microcontroller in FIG. 1a. FIG. 2 shows the door lock detector 6 sending a signal to microcontroller label 5. The microcontroller measures how many minutes the safe remains locked.

3/Some designated period of time (for example 30 minutes) elapses since they have locked the safe. This time is measured by the microcontroller FIG. 2 label 5.

4a/ In FIG. 1, the period of time of (3) passes and a unique coded transmission (b) is sent from the remote control transmitter (c) to the receiver (d). This code includes the identification code of the safe (Safe ID Code) and an activation code to commence rental billing. FIG. 2 shows the code (4) being sent by (3) the data radio transmitter. This signal travels throughout the room carrying both the type of signal (theft or usage) and the room or safe ID number.

4b/ A motion detector or other tamper detection sensor can also trigger a data transmission through the remote control transmitter in (c) to the receiver (d) by sending the Safe ID Code plus a code for theft. This is shown in FIG. 2 number 7. The transmitter 3 is also shown in FIG. 2 sending its signal 3 to the antenna 2.

5/The wireless receiver in FIG. 1d detects received coded signal that an activation or theft detection signal has been sent for a known room and safe. The data is re-constructed from the radio signal (e) and is sent to a single chip microcontroller (f) located near the room telephone, internet service connection or any other Building Communication Network (BCN). Throughout this document BCN will be used to refer to this kind of service. Examples of a BCN would be a spread spectrum network or a power line modem network.

The preferred implementation will be an internet connection. This is shown in FIG. 3. Here in FIG. 3 the signal gets decoded and reconstructed. It is then passed on through the serial to internet translator module. Several of these translators are available through a Korean company called Sollae. They make several wireless WIFI and ethernet wire translators. This allows the received signal to be passed along to the building wide internet connection . The billing or security information is passed through to the hotel's main computer system.

Note: all references in the rest of this section will be to FIG. 1.

6a/ If the communication link is a telephone, first it waits for the line to be free. When the line is free it sends its activation or theft code using the modem (g) and sending the data through the phone line (h). The safe identification may be inferred from either the Safe ID Code or the caller id code of the phone.

6b/ If the communication link is via an internet link, the data is sent through link modem (i) and through the internet network system (j). This system can be a wireless internet link (WIFI) or a wire bound one. The activation or theft code is sent along with the Safe ID Code.

6c/ If the communication link is via another Building Communication Network (BCN), the data is sent through the BCN link modem (n) and through the BCN (o). The activation or theft code is sent along with the Safe ID Code.

7/The activation or theft code is received by the telephone, internet system, or the BCN located in the computer control centre of the hotel. This data is passed to the billing and security computers (k) through modems (l), (m) or (p).

8/A billing code results in the guest being billed for safe use and a theft code tiggers a security alert in the building. The room number is easily identified by the Safe ID Code.

The safe can also be identified by the Caller ID if a telephone is used and the safe control system has access to the PBX telephone exchange information (q). This is shown at the bottom right of the diagram. Using this information the room number can be determined in which the safe is located. This can be seen as “q” in FIG. 1 and supplies an alternative method of receiving the room location, only in the case of a telephone BCN system.

Preferred Safe Construction

The safe lock detection, timing, motion detection and data formation should be carried out by the same microcontroller that is used to run the safe. All of these functions can be orchestrated by a single microcontroller. This microcontroller should send the data directly into the small (and preferably licence free) transmitter that is typically used for automobile remote control. The antenna of this transmitter could be integrated into a plastic keyboard area of the safe which is used to open and close the lock mechanism.

Remote Radio Receiver/modem.

An off the shelf radio receiver that is typically used for automobile door locks is used to receive the wireless data. This is interfaced to a single chip microcontroller. This microcontroller is capable of either telephone modem operation or TC/IP operation. The microcontroller will send the data directly over the telephone system or the internet connection. Initially the product has been prototyped with these discrete modules. Ideally all of these functions should be integrated into a single chip. This Remote Radio Receiver/modem will make the data available at any central location that has telephone access or local internet access.

Special Terminology

The word “internet” is being used in this case to mean either a local ethernet based network system or a wireless network system. It may or may not use the TCP/IP protocol as is usually used for internet linking. A microcontroller is a small single chip computer such as the Microchip 16f876.

### CONCLUSIONS

This simple system can be adapted to both large and small hotels. It can be used for rental billing of the room safes and for theft detection. Billing for safe usage is fully automatic and is based on detected opening and closing of each safe. This activity is passed to a central computer for automated billing.

This simple system is readily applicable to all hotel designs. The telephone, internet link, or other BCN in each room can be used for the distribution of the signals to a remote computer area for data processing.

The main advantage over a conventional system of safe control is the elimination of a wired network dedicated to the operation of the safes. Such a dedicated system, which is very expensive to construct, is not required in the case of our invention.

### FIGURES AND DIAGRAMS

FIG. 1 is a functional diagram of the system. It shows all the components of a typical system. Items are only referred to in the Functional Description of the invention. Labels are from “a” to “q”.

FIG. 2 is a diagram of the safe with microcontroller, sensors and short range transmitter.

FIG. 3 is a diagram of the wall link that receives the transmissions and diverts them into the building wide network.

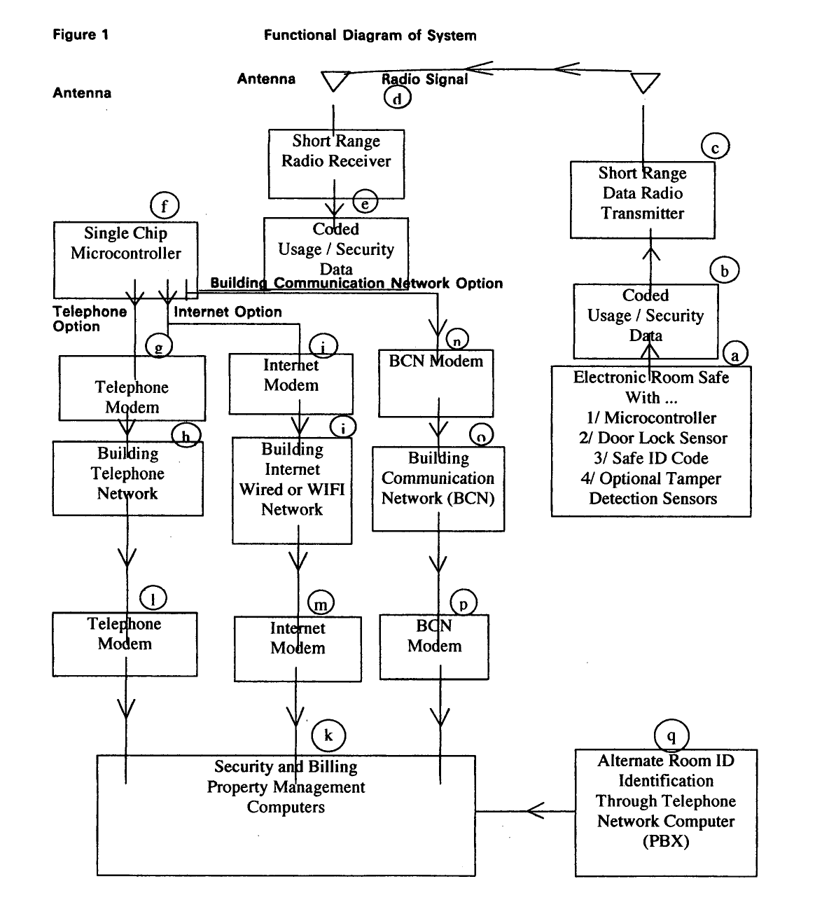

Figure Letters for FIG. 1

a Room safe with sensors, microcontroller and transmitter.
b Coded data
c Short range transmitter
d Short range receiver
e Coded data containing room name and status (theft or usage)
f Microcontroller to decode data
g Standard telephone modem
h The building telephone network.
i Internet Modem
j Building Internet System
k Central computer for security and billing
l Standard telephone modem
m Internet modem.
n Miscellaneous building wide communication network modem (BCN)
o Building Wide Communication Network (BCN)
p BCN modem
q Alternate PBX derived room number (if telephone system is used).

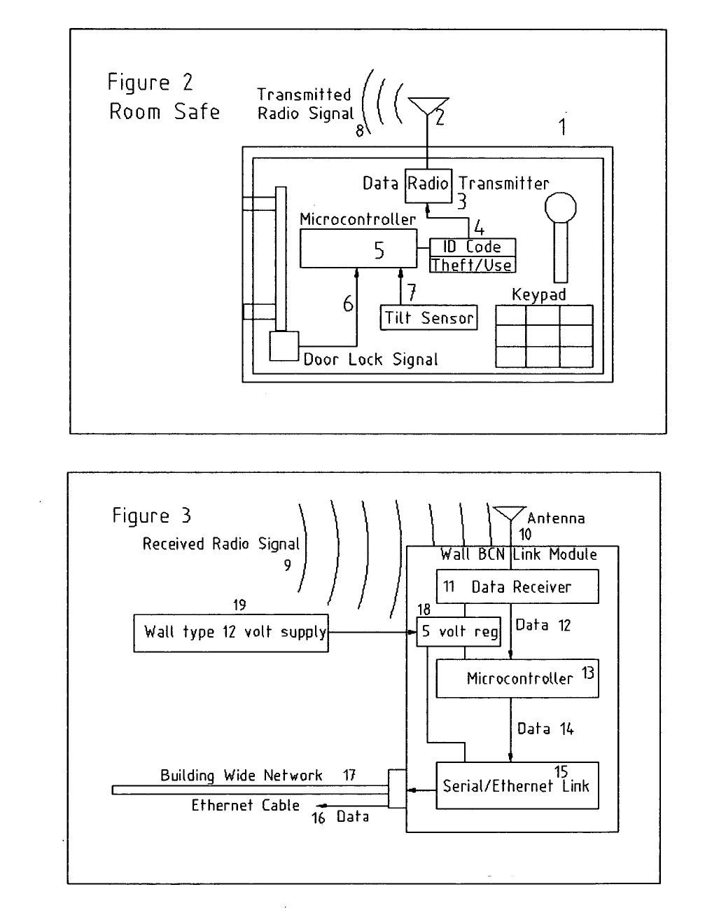

FIG. 2 Diagram Numbers
1 Special purpose room safe
2 Transmitting antenna
3 Data transmitter (off the shelf for car door locks.)
4 ID code and Theft/Usage code
5 Microcontroller such as the PIC16F876
6 Door lock signal
7 Tilt sensor
8 Transmitted radio signal
   FIG. 3 Diagram Numbers
9 Received radio signal
10 Receiving antenna
11 Coded data radio receiver
12 Decoded data
13 Microcontroller
14 Decoded data
15 Serial to Ethernet converter (Korean company Sollae makes many such models both wireless and wired.)
16 Internet carried data
17 Building wide internet system
18 5 volt regulator to power components in FIG. 3
19 Wall plug type 12 volt regulator

1. A room safe usage and tampering notification system for a hotel comprising:
A plurality of safes with locking safe mechanisms,
A low range transmitter triggered by said safe mechanism, which when said mechanism is locked and remains locked for a set time, a coded radio message is generated whereby each safe is uniquely identified,
A microcontroller which detects that the safe is locked or is being tampered with and sends a message to the transmitter,
A message code that uniquely identifies the safe and whether it is locked or unlocked,
A digital receiver for the transmitter,
A single chip microcomputer which decodes the message from the microcontroller,
A standard building wide communication network, and
A central computer linked into the communication network to pass the coded radio message for the safe to a guest room rental account.

2. The system of claim 1 wherein the single chip microcomputer stores a unique
Safe ID Code in its circuitry,
Detects that the safe mechanism has been locked for a minimum period, and
Sends a message to the attached transmitter.

3. The system of claim 2, wherein a tamper detection mechanism in the safe causes the single chip computer to send an alarm message to the transmitter.

4. The system of claim 1, wherein each safe transmitter has a range of 20 meters.

5. The system of claim 1 wherein each hotel suite has a receiver and single chip computer capable of receiving and decoding the local suite's signal,
wherein the receiver will only respond to the safe in the same guest suite through use of a unique code programmed into each safe and each receiver system, wherein the receiver/single chip computer will relay the Safe ID Code and Usage Status Code to the building wide communication network.

6. The building-wide communication network of claim 1, wherein the network includes one of a wired internet or computer network system, a WIFI or wireless internet link, a magnetic or inductive computer network.

7. A method of monitoring a distributed array of room safes in a hotel complex comprising the steps:
(a) Each safe has a unique ID Code,
(b) A small single chip computer detects either lock tampering or a locked status of the safe for a minimum period of time,
(c) The state of the safe (tampered or locked) is communicated as a Usage Status Code (USC),
(d) A short range radio transmits the Safe ID Code and Usage Status code,
(e) A receiver located close to a building-wide communication network receives a signal and passes it to the building-wide computer or other communication network,
(f) This signal is passed to the Building Wide Communication network (BCN),
(g) A central computer connected to the BCN to receive ID numbers and Status codes passes them along to the hotel staff.
